(19) United States
(12) Patent Application Publication
(10) Pub. No.: US 2013/0307847 A1
(43) Pub. Date: Nov. 21, 2013

(54) RENDERING AND ENCODING ADAPTATION TO ADDRESS COMPUTATION AND NETWORK

(71) Applicants: Sujit Dey, San Diego, CA (US); Shaoxuan Wang, La Jolla, CA (US)

(72) Inventors: Sujit Dey, San Diego, CA (US); Shaoxuan Wang, La Jolla, CA (US)

(73) Assignee: THE REGENTS OF THE UNIVERSITY OF CALIFORNIA, Oakland, CA (US)

(21) Appl. No.: 13/988,971

(22) PCT Filed: Dec. 6, 2011
(86) PCT No.: PCT/US11/63541

§ 371 Date: Aug. 5, 2013

Related U.S. Application Data
(60) Provisional application No. 61/419,951, filed on Dec. 6, 2010.

(51) Int. Cl. G06T 15/00

(52) U.S. Cl. CPC G06T 15/005
USPC 345/419

(57) ABSTRACT

A method for graphics rendering adaptation by a server that includes a graphics rendering engine that generates graphic video data and provides the video data via a communication resource to a client. The method includes monitoring one or both of communication and computation constraint conditions associated with the graphics rendering engine and the communication resource. At least one rendering parameter used by the graphics rendering engine is set based upon a level of communication constraint or computation constraint. Monitoring and setting are repeated to adapt rendering based upon changes in one or both of communication and computation constraints. In preferred embodiments, encoding adaptation also responds to bit rate constraints and rendering is optimized based upon a given bit rate. Rendering parameters and their effect on communication and computation costs have been determined and optimized. A preferred application is for a gaming processor miming on a cloud based or data center server that services mobile clients over a wireless network for graphics intensive applications, such as massively multi-player online role playing games, or augmented reality.

### PRIORITY CLAIM AND REFERENCE TO RELATED APPLICATION

The application claims priority under 35 U.S.C. §119 from prior provisional application Ser. No. 61/419,951, which was filed Dec. 6, 2010.

### FIELD

An example field of the invention is graphics rendering. Other example fields of the invention include network communications, and cloud computing. Example applications of the invention include cloud based graphics rendering, such as graphics rendering used in cloud based gaming applications, augmented reality and virtual reality applications.

### BACKGROUND

In a typical graphics rendering pipeline such as shown in FIG. 1, all the graphic data for one frame is first cached in a display list. When a display list is executed, the data is sent from the display list as if it were sent by the application. All the graphic data (vertices, lines, and polygons) are eventually converted to vertices or treated as vertices once the display list starts. Vertex shading (transform and lighting) is then performed on each vertex, followed by rasterization to fragments. Finally, the fragments are subjected to a series of fragment shading and raster operations, after which the final pixel values are drawn into the frame buffer. Graphic rendering is used to apply texture images onto an object to achieve an appearance effect, such as realism. Texture images are often pre-calculated and stored in system memory, and loaded into GPU texture cache when needed. In a client-server application, the client typically includes the graphics rendering pipeline to limit demands on the communication medium between the client and server.

There are various applications that require significant graphics rendering and communications between a client and server. One type of application is web based gaming including multiple players. An example gaming genre is known as massively multiplayer online role playing games (MMORPG). To provide high quality experiences among users, these games typically leverage client side graphics rendering. Minimum system requirements can require significant processor, graphics engine and memory standards. In some instances, the games have adjustable rendering settings that can be manually changed upon installation or later set by users. These settings are used to play the games, and the settings can later be changed through a set-up menu. The server job is relegated typically to minimal information required to update player interaction with the environment so that bandwidth problems are less likely to interfere with the real-time playing experience. The client side demands for video rendering has limited the type of client devices that are able to handle popular MMORPG games to desktop style computers and game consoles having broadband internet connections.

At least one MMORPG has been developed for portable devices such as Android® and iOS devices. This game is known as Pocket Legends. The Pockets Legend's game was specially developed for mobile platforms, but still requires a 30M installation space indicating the demands placed on the mobile device. Despite the large installation (compared to the resources of many mobile platforms) and the placing of the graphics rendering burden on the mobile device, the graphics used in the game is generally considered graphically inferior to popular games for PC, MAC and game console games like World of Warcraft and Perfect World. Users also report lag, response, freezing and installation problems. Other mobile platform games have been developed, but are known as MMO games to denote the mobile platform. These games also have typically large installation requirements and limitations that vary greatly from true MMORPG games.

Especially in the case of mobile clients, therefore, graphic rendering has been placed on the client side burdening the mobile device. Graphic rendering is not only very computation intensive, it can also impose severe challenges on the limited battery capability of an always-on mobile device. The power and rendering capabilities of mobile devices are expected to increase, but not as rapidly as the advances and requirements of 3D rendering. This will leave a growing gap.

Cloud based rendering in the game environment has recently been provided by companies such as Onlive and Gaikai. Graphic rendering in a remote server, instead of on the client, has been recently adopted as a way to deliver Cloud based Gaming services. Examples of Cloud Gaming are the platforms used by Onlive and Gaikai. However, existing Cloud Gaming techniques do not change the graphic rendering settings on the fly during a gaming session, depending on network conditions. Also, these games have large network bandwidth requirements, typically only permitting games to played on a WiFi network, or limit the game play to specific network conditions.

Traditional bitrate encoding adaptation techniques can adjust to network constraints. These techniques leverage only the encoding with increased compression of video data. Such video bitrate adaptation techniques can be used to encode the rendered video to lower bit rates so as to meet constraints of available network bandwidth. However, when the available network bandwidth goes below a certain level, adapting video encoding bitrate often leads to unacceptable video quality. Example bitrate encoding adaptation techniques are disclosed in the following publications: Z. Lei and N. D. Georganas, “Rate Adaptation Transcoding For VideoStreaming Over Wireless Channels,” Proceedings of IEEE ICME, Baltimore, Md. (June 2003); S. Wang, S. Dey, “Addressing Response Time and Video Quality in Remote Server Based Internet Mobile Gaming,” Proceedings of the IEEE Wireless Communications & Networking Conference, Sydney, Australia (April 2010); S. Floyd, M. Handley, J. Padhye, and J. Widmer, “Equation-Based Congestion Control for Unicast Applications,” Proc. ACM SIGCOMM 2000, Stockholm, Sweden (August 2000). R. Rejaie, M. Handley, and D. Estrin, “RAP: An End-to-end Rate-based Congestion Control Mechanism for. Realtime Streams in the Internet,” Proc. IEEE INFOCOM 1999, New York (March 1999). The resultant drop-off in quality can be precipitous in instances of significant constraints and is accordingly poorly suited for many applications, such as graphic intensive game playing.

### SUMMARY OF THE INVENTION

A method for graphics rendering adaptation by a server that includes a graphics rendering engine that generates graphic video data and provides the video data for encoding and communication via a communication resource to a client. The method includes monitoring one or both of communication and computation constraint conditions associated with the graphics rendering engine and the communication resource. At least one rendering parameter used by the graphics rendering engine is set based upon a level of communication constraint or computation constraint. Monitoring and setting are repeated to adapt rendering based upon changes in one or both of communication and computation constraints. In preferred embodiments, encoding adaptation also responds to bit rate constraints and rendering is optimized based upon a given bit rate. Rendering parameters and their affect on communication and computation costs have been determined an optimized. A preferred application is for a gaming processor run a cloud based server that services mobile clients over a wireless network for graphics intensive games, such as massively multi-player online role playing games.

### BRIEF DESCRIPTION OF THE DRAWINGS

FIG. 1 (prior art) illustrates the stages of a typical graphics rendering pipeline;

FIGS. 2A-2D show the different visual effects of a game scene from the free massively multiplayer online role playing game “PlaneShift” when rendered in different settings of view distance and texture detail (LOD): FIG. 2A shows a 300 m view and high LOD; FIG. 2B shows a 60 m view and high LOD; FIG. 3D shows 300 m view and medium LOD; and FIG. 2D shows 300 m view and low LOD;

FIGS. 3A-3H show experimentally measured computation cost and communication cost as affected by reduction in a number of levels for realistic effect rendering parameters in accordance with an embodiment of the invention;

FIG. 4 illustrates an adaptation level matrix used in a preferred embodiment rendering and encoding adaptation method of the invention;

FIG. 5 illustrates a completed adaptation level matrix for a particular application of a preferred embodiment rendering and encoding adaptation method of the invention;

FIG. 6 illustrates a preferred level selection method for selecting an adaptation level in a preferred embodiment rendering and encoding adaptation method of the invention;

FIGS. 7A and 7B illustrate experimental data used to determine optimal rendering parameters for an example implementation;

FIG. 8 illustrates a preferred embodiment joint rendering and encoding method that responds to network delay; and

FIG. 9 is a block diagram of a cloud based mobile gaming system in accordance with a preferred embodiment of the invention.

### DETAILED DESCRIPTION OF THE PREFERRED EMBODIMENTS

The invention provides methods for graphics rendering and encoding adaptation that permits on the fly adjustment of rendering in response to constraints that can change during operation of an application. A preferred application is cloud based rendering and encoding, where a cloud based server takes the burden of graphics rending to simplify client side computation requirements. The adaptive graphic rendering method can adjust, for example, in response to a reduction in available network communication bandwidth or increase in network communication latency, or from client side feedback regarding client characteristics. Preferred methods of the invention weigh a cost of communication and a cost of computation and adaptively adjust the rendering and encoding to meet a recognized constraint while maintaining a quality graphical presentation.

A method for graphics rendering adaptation by a server that includes a graphics rendering engine that generates graphic video data and provides the video data via a communication resource to a client. The method includes monitoring one or both of communication and computation constraint conditions associated with the graphics rendering engine and the communication resource. At least one rendering parameter used by the graphics rendering engine is set based upon a level of communication constraint or computation constraint. Monitoring and setting are repeated to adapt rendering based upon changes in one or both of communication and computation constraints. In preferred embodiments, encoding adaptation also responds to bit rate constraints and rendering is optimized based upon a given bit rate. Rendering parameters and their affect on communication and computation costs have been determined an optimized. A preferred application is for a gaming processor to run on a cloud based server that services mobile clients over a wireless network for graphics intensive games, such as massively multi-player online role playing games.

In applications where graphic rendering is performed remotely by servers (such as cloud servers), and the rendered video is compressed and transmitted to a client over a network, there are significant computation and communication costs. Computation costs are associated with rendering and video encoding, and communication costs are associated with the transmission of rendered video data over the network the encoded video.

For example, to implement cloud based mobile gaming, the rendering and video compression (encoding) tasks have to be performed for each mobile gaming session, and each encoded video has to be transmitted over a network to the corresponding mobile device. This process has to be performed every time a mobile user issues a new command in the gaming session. Without adaptation according to the present invention, the heavy computation and communication costs may overwhelm the available server resources, and the network bandwidth available for each rendered video stream, adversely affecting the service cost and overall user experience.

The invention provides rendering adaptation technique, that can reduce the video content complexity by lowering rendering settings, such that the required bitrate for acceptable video quality will be much less than before but not solely by adjustment of the encoding rate. The rendering adaptation of the can also be used to address computation constraints or other conditions such as feedback about video that has been received, e.g., lags in display, pixellation, and poor quality. The invention includes an adaptive rendering technique, and a joint rendering and encoding adaptation technique, which can simultaneously leverage preferred rendering adaptation technique and any video encoding adaptation technique to address the computation and communication constraints, such that the end user experience is maximized.

Embodiments of the invention identify costs associated with graphics rendering and network communications and provide opportunities to reduce these costs as needed. Preferred embodiments of the invention will be discussed with respect to network based gaming. Artisans will recognize extension of the preferred embodiments to other graphics rendering and network applications.

Preferred embodiments of the invention will now be discussed with respect to the drawings. The drawings may include schematic representations, which will be understood by artisans in view of the general knowledge in the art and the description that follows. Features may be exaggerated in the drawings for emphasis, and features may not be to scale.

A preferred embodiments is 3D rendering adaptation scheme for Cloud Mobile Gaming, which includes an off-line or preliminary step of identifying rendering settings, and also preferably encoding settings, for different adaptation levels, where each adaptation level represents a certain communication and computation cost and is related to specific rendering and encoding levels. The settings for each adaptation level are preferably optimized according to objective and/or subjective video measures. During operation, a run-time level-selection method automatically adapts the adaptation levels, and thereby the rendering settings, such that the rendering cost will satisfy the communication and computation constraints imposed by the fluctuating constraints, such as network bandwidth, server available capacity, or feedback relating to previous video. The choices that can be used to identifying rendering settings.

Two variables are defined in the preferred embodiments with respect to adaptation levels. The Communication. Cost (CommC) the bit rate of compressed video, such as game video delivered over a communication resource, e.g., a wireless network. CommC is affected not only by the video compression rate (that determines hit rate), but also by content complexity. Thus, CommC can be reduced by reducing the content complexity of game video.

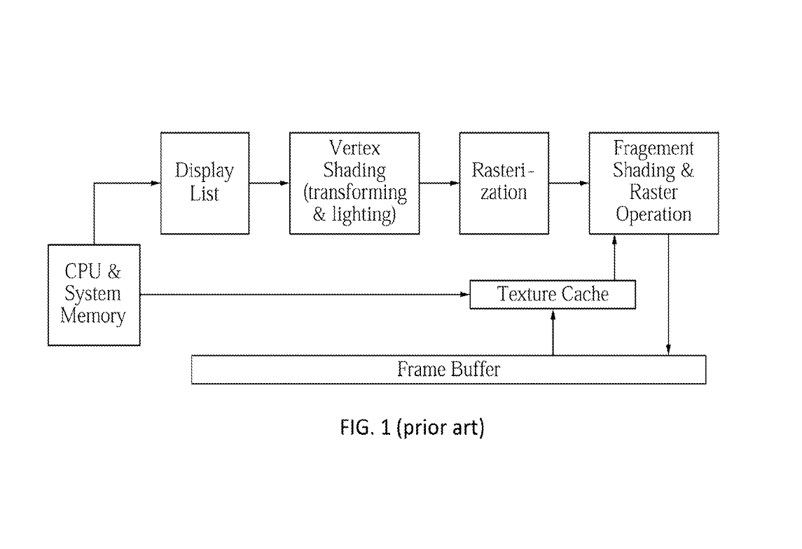

The Computation Cost (CompC) is mainly consumed by graphic rendering, which can be reflected by the GPU utilization by the rendering engine, e.g., a game engine. When the rendering engine is the only application using the GPU resource, CompC is equivalent to the product of rendering Frame Rate (FR) and Frame Time (FT), the latter being the time taken to render a frame. Most of the stages in FIG. 1 are processed separately by their own special-purpose processors in a typical GPU. The FT is limited by the bottleneck processor. To reduce CompC, the computing load on the bottleneck processor must be reduced.

There are various choices for reducing the computing load. Some choices will be illustrated with respect to a game. In a game application, one aspect of a preferred embodiment includes the choice of reducing the number of objects (objects deemed to be of lesser importance) in the display list, as not all objects in the display list created by game engine are necessary for playing the game. For example, in the Massively Multiplayer Online Role-Playing Game (MMORPG) genre of games, a player principally manipulates one object, an avatar, in the gaming virtual world. Many other unimportant objects (e.g., flowers, small animals, and rocks) or far way avatars will not affect a user playing the game. Removing some of these unimportant objects in display list will not only release the load of graphic computation but also reduce the video content complexity, and thereby CommC and CompC.

A second aspect of a preferred embodiment for adaptive rendering is related to the complexity of rendering operations. In the rendering pipeline, many operations are applied to improve the graphic reality. The complexities of these rendering operations directly affect CompC. More importantly, some of the operations also have significant impact on content complexity, and thereby CommC, such as texture detail and environment detail. Scaling these operations in preferred embodiments permits CommC and CompC to be scaled as needed to meet network and other constraints.

Example Parameters to Reduce Rendering Complexity

Many parameters can reduce rendering complexity. Preferred parameters can be discussed. These relate to the second aspect discussed above of reducing rendering complexity.

Realistic effect: Realistic effect includes four primary parameters: color depth, anti-aliasing, texture filtering, and lighting mode. Color depth refers to the amount of video memory that is required for each screen pixel. Anti-aliasing and texture filtering are employed in the “fragment shading” stage as shown in FIG. 1. Anti-aliasing is used to reduce stair-step patterns on the edges of polygons, while texture filtering is used to determine the texture color for a texture mapped pixel. The lighting mode will decide the lighting methodology for the “vertex shading” stage in FIG. 1. Common lighting models for games include lightmap and vertex lighting. Vertex lighting gives a fixed brightness for each corner of a polygon, while the lightmap model adds an extra texture on top of each polygon which gives the appearance of variation of light and dark levels across the polygon. Each of above four parameters only affects one stage of graphic pipeline. Varying any one of them will only have an impact on one special-purpose processor, which may not reduce the load on a bottleneck processor, which can change depending upon the conditions causing delay. In a preferred embodiment, adapting, i.e., reducing or increasing the realistic effect, all four parameters are adjusted to produce a corresponding reduced/increased CompC.

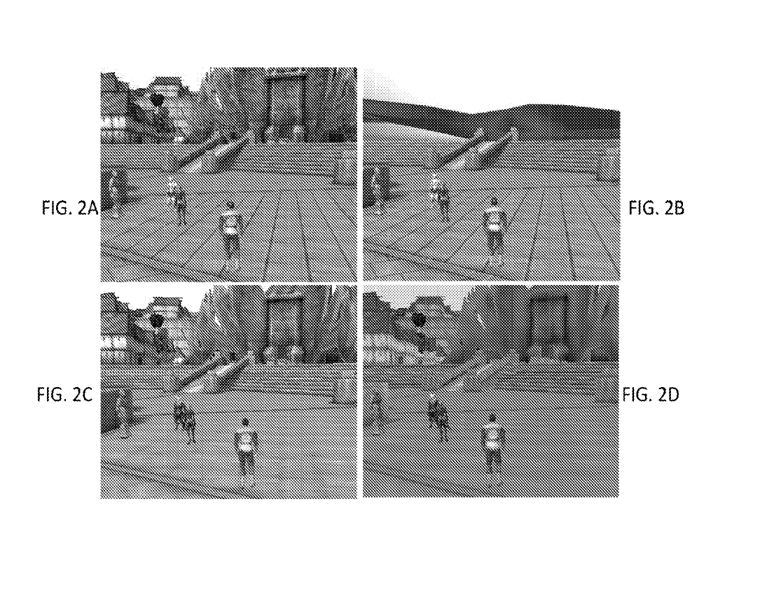

View distance: A view distance parameter determines which objects in the camera view will be included in the resulting frame based upon the distance from the camera. This parameter can be sent to the display list for graphic rendering. The effect is best understood with respect to an example. FIGS. 2A and 2B compare the visual effects in two different view distance settings (300 m and 60 m) in the game PlaneShift. Though shorter view distance has impairments on user perceived gaming quality, the game will be still playable if the view distance is controlled above a certain acceptable threshold. Since the view distance affects the number of objects to be rendered, the view distance impacts CompC as well as the CommC.

Texture detail (aka Level Of Detail (LOD)). A texture detail parameter controls the resolution of textures and the number of textures are used to present objects. The lower texture detail level, the lower resolution the textures have, and the number of possible textures can also be specified. As shown in FIGS. 2C and 2D, the surfaces of objects get blurred with decreasing texture detail. It is also important to be aware of that reducing texture detail has a less impact on important objects (avatars and monsters) than unimportant objects (ground, plants, and buildings), because the important objects in game engines have many more textures than unimportant objects. Preferred embodiments leverage this information to properly downgrade the texture detail level for less communication cost, while mainatining the good visual quality of important objects.

Environment detail: An environment detail parameter affects background scenes. Many objects and effects (grass, flowers, and weather) are applied in modern games, especially the role player games, to make the virtual world look more realistic. Such details often do not directly impact the real experience of users playing the game. Therefore, this parameter can also be changed to eliminate (or add back) some environment details objects or effects to reduce CommC and CompC.

Rendering Frame Rate: The total computation cost of GPU is the product of rendering cost for a frame and frame rate. While the above parameters are mainly focusing on adapting the computation cost for one frame, the rendering frame rate is a vital parameter in adapting the total computation cost. In preferred embodiments, the rendering frame rate is adapted together with the encoding frame rate, which changes the rendering rate and also consequentially changes the resulting video bit rate.

Characterization of Communication and Computation Costs

A popular online 3D game PlaneShift is used as an example to characterize how the adaptive rendering parameters affect the Communication Cost and Computation Cost.

TABLE I
EXAMPLE RENDERING PARAMETERS AND
EXPERIMENT VALUES FOR PLANESHIET

| Parameters | | Experiment Values | | |
|---|---|---|---|---|
| Realistic Effect | | H(High) | M(Medium) | L(Low) |
| | color depth | 32 | 32 | 16 |
| | multi-sample (factor) | 8 | 2 | 0 |
| | texture-filter (factor) | 16 | 4 | 0 |
| | lighting mode | Vertex light | Lightmap | Disable |

| | |
|---|---|
| Texture Detail (down sample) | 0, 2, 4 |
| View Distance (meter) | 300, 150, 120, 100, 70, 60, 40, 20 |
| Enabling Grass | Y(Yes), N(No) |

PlaneShift is a cross-platform open source MMORPG game. Its 3D graphic engine is developed based on Crystal Space 3D engine. Table I shows the four example rendering parameters (corresponding to the four adaptation parameters introduced earlier), and their values we will use. The table uses many of the parameters discussed above, but other parameters including frame rate can also be used. Additional example parameters include rendering frame rate, rendering screen resolution, and rendering background world details.

As mentioned above, “Realistic Effect” consists in a preferred embodiment of four factors: color depth, multi-sample (technique that uses additional samples to anti-alias graphic primitives), texture-filter, and lighting mode. In preferred embodiments, a range of values is chosen reflecting a range of CompC costs. The above table provides an example where three levels, with the corresponding values shown in Table I for low, medium and high renderings. As indicated in the table, each parameter need not change for each level. In the example, the color depth stays constant for the high and medium levels, while the other parameters change for each level.

For the parameter “Texture Detail”, three texture down sample rates {0, 2, 4} are employed. Higher down sample rates correspond to lower resolution textures. Similarly, we use five choices for the parameter “View Distance”, and two options for the effect of the Environment Detail parameter “Enabling Grass”. Note that the lowest setting selected for any of the parameters is the minimal user acceptable threshold, such that the gaming quality using the settings in Table I will always be above the acceptable level.

Experiments were conducted to test the effect altering the adaptive parameters presented in Table 1. A 4-tuple S can be used to denote a rendering setting when there are four parameters. The elements of S indicate the value of the four adaptive rendering parameters respectively used in a rendering setting. Experiments to measure the CompC and CommC for every possible rendering setting S using the settings of parameters in Table I were determined experimentally. The experiments were conducted on a desktop server that integrates a NVIDIA Geforce 8300 graphic card. For each setting S, a game avatar roaming in the gaming world was controlled for about 30 seconds along the same route. The Quantization Parameter (QP) of video encoder h.264 was kept at 28, while the encoding frame rate was kept at 15 fps. The compressed video bit rate (CommC) and GPU utilization (CompC) were measured.

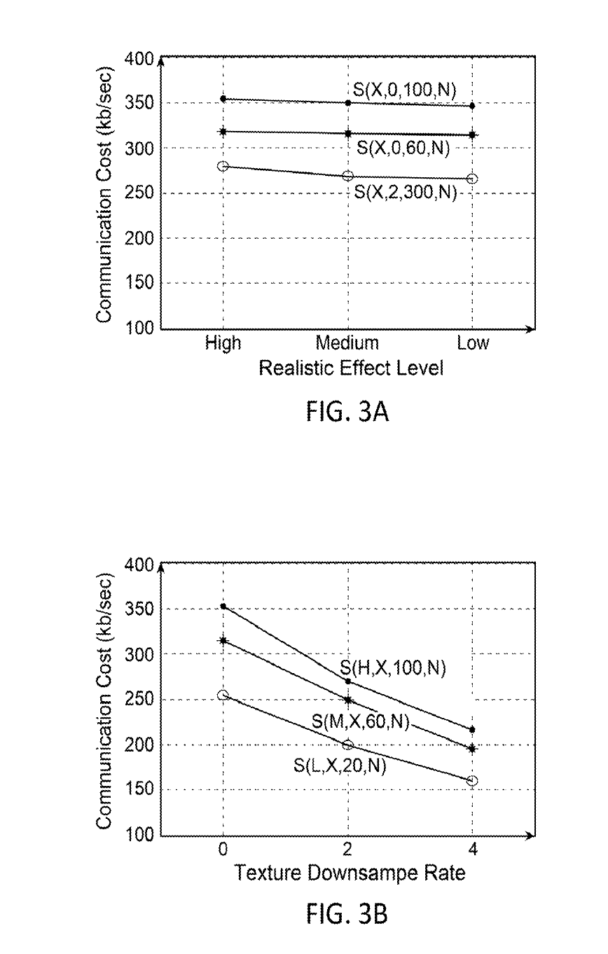

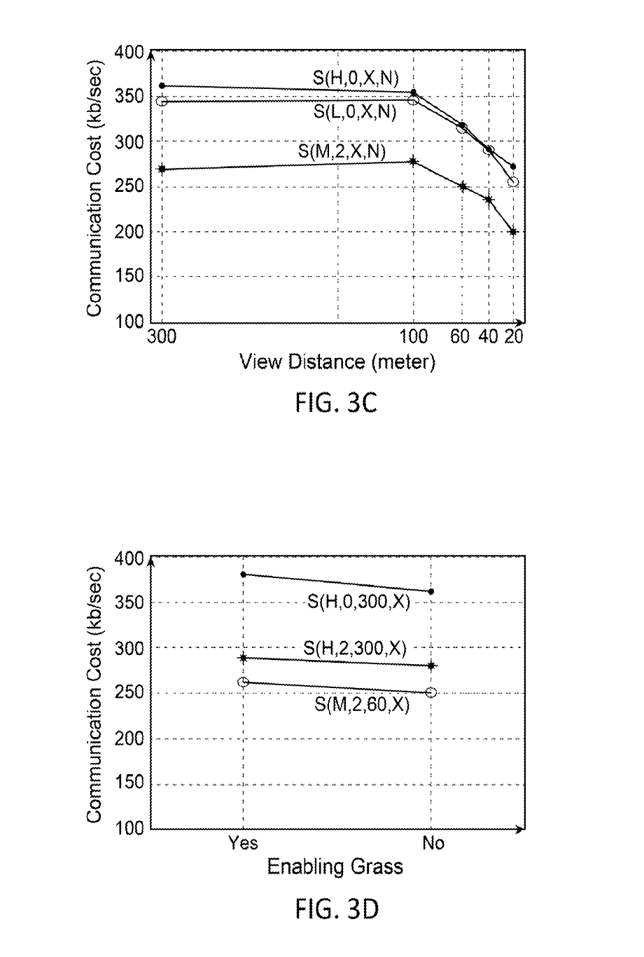

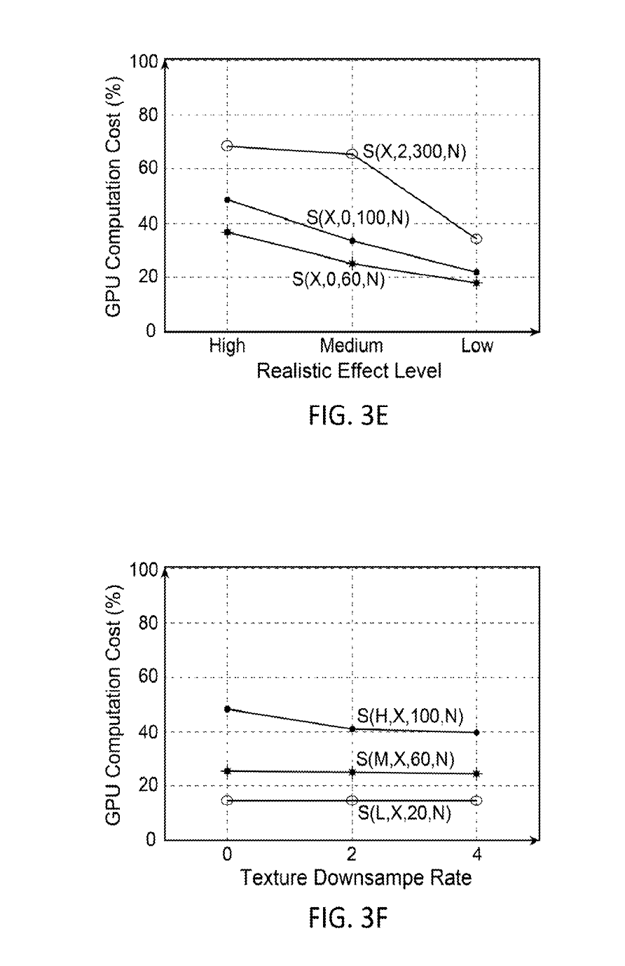

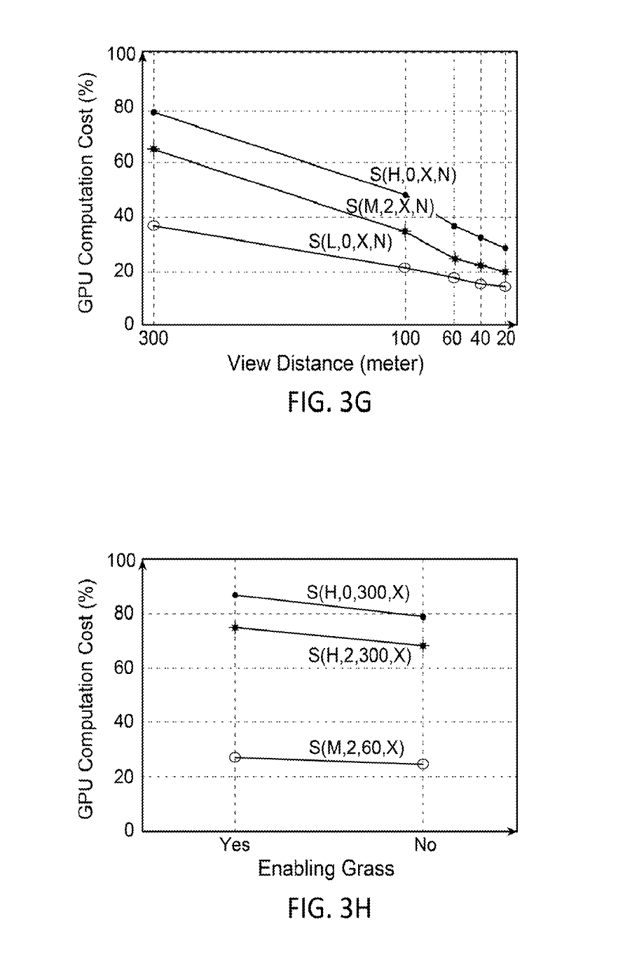

FIGS. 3A-3H show some representative data points from the experimental results for the plane shift game. As other applications have different video environments, an aspect of the invention involves preliminary testing or evaluation for objective data on the cost of communication (CommC) and the cost of computation (CompC). Each plot represents a rendering setting where one of the rendering parameters is varied (marked by “X” in the associated setting) while keeping the other parameters to fixed values shown in the setting tuple. FIGS. 3A-3H does not show results of all possible settings, and the results of CompC will be different for different hardware platforms. The experiments and data in FIGS. 3A-3H revealed the following information:
1) Realistic Effect has a great impact on CompC. But it has little impact on CommC, because it does not affect video content complexity.
2) Texture Detail significantly affects CommC, as the highest video bit rate is about 1.6 times of the lowest video bit rate when the texture sample rates were made lower. However, texture detail has very little effect on CompC because the reduced textures in different levels for an object are pre-calculated and saved in memory. The pre-calculation is done normally so that the graphic pipeline can load the textures quickly without any additional computation.
3) View Distance significantly affects both CommC and CompC. While its impact on CompC is almost linear, impact on CommC becomes clear only below a certain point (100 meters).
4) The impact of Enabling Grass (a background detail parameter) on CommC and CompC are limited (up to 9%), mainly due to the simple design of this effect in PlaneShift.

In preferred embodiments, the characterizing measurement is an off-line pre-processing/preliminary step, resulting in a look-up table of cost models for each rendering setting. The look-up table can be subsequently used for run-time rendering adaptation.

Adaptive Rendering with Optimized Rendering Settings Look-Up

The testing or estimation of parameters as described above can be used to set levels for adaptive rendering. Then, application cost is modified on the fly in response to conditions by adjusting the adaptation level. The higher adaptation level, the higher CommC and CompC will be. With a look up table, each adaptation level has a corresponding rendering setting to identify the optimal rendering setting for each adaptation level in advance. The possible rendering settings can be large and each set of different rendering parameters can have different impacts on CommC and CompC.

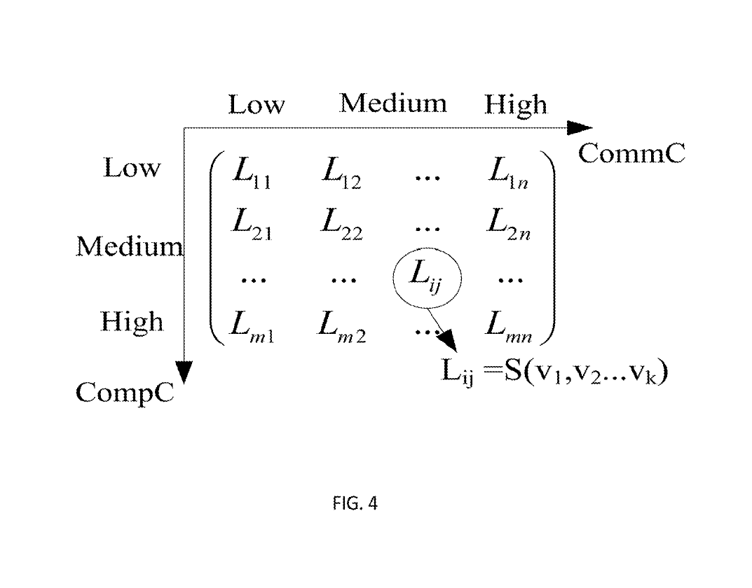

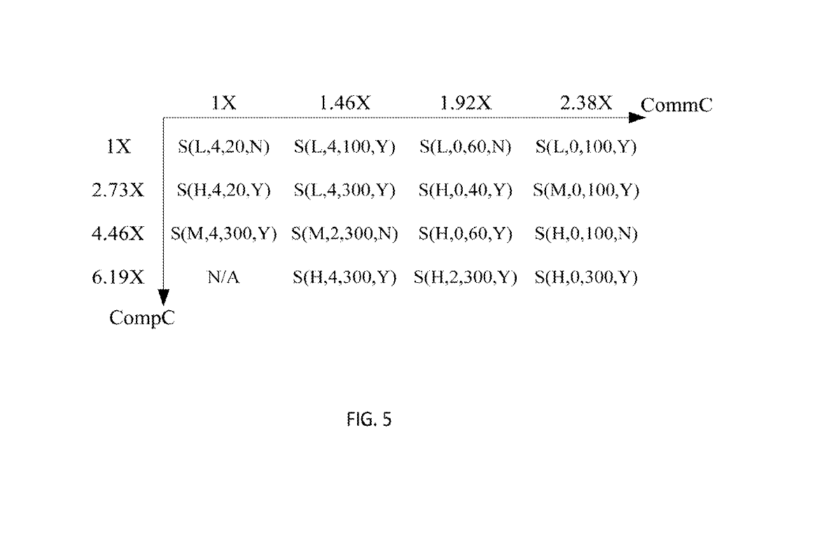

FIG. 4 presents a look-up table that relates adaptation levels to rendering parameters. As seen in FIG. 4, the computation cost and communication cost can be divided into in levels and n adaptation levels, respectively defining increasing CommC and CompC. In the table of FIG. 4, the higher level denotes the higher resource cost. The m×n matrix L represents all the adaptation levels.

For example, adaptation level has the computation cost at level i and communication cost at level j. In each adaptation level, there is a k-dimensional (k is the number of rendering parameters) rendering setting S. The elements of S indicate the values of the rendering parameters. All the adaptation levels Lᵢⱼ defined in the adaptation matrix in L should be able to provide acceptable gaming quality to the user. Adaptation levels preferably use the highest possible CommC and CompC, but adjust lower when resources are limited.

With defined adaptation levels and an adaptation matrix L, optimal rendering settings in the matrix L for different adaptation levels can be selected for optical rendering. A preferred technique first identifies the highest setting Lₘₙ and lowest setting L₁₁. Lₘₙ provides the best quality but costs the most resource, while L₁₁ has minimal CommC and CompC but provides the minimal acceptable quality below which user experience reaches an unacceptable level (defined by objective video measures or subjective testing consistent with the preliminary off-line analysis discussed above). The preliminary/off line experiments described above we can know the CommC and CompC of highest setting Lₘₙ and lowest setting L₁₁.

A preferred embodiment evenly divides the CommC and CompC ranges between the desired numbers of levels, considering that the effect of adaptation will be obvious if the cost differences between adaptation levels are significantly distinct. Knowing the CommC and CompC for each level, all other optimal rendering settings can be selected, according to the following two requirements: 1) CommC and CompC of the optimal setting for a level should meet the desired CommC and CompC for the level; 2) of all the settings that meet the above requirement, the optimal setting should provide the best gaming quality.

A demonstrative example can be illustrated with PlaneShift to illustrate how selection of optimal rendering settings for this game. The example uses a 4×4 adaptation matrix for PlaneShift. The setting of L₁₁ for PlaneShift is S(L,4,20,N) using the lowest values in Table I, while the setting of L₄₄ is S(H,0,300,Y) using the highest values in Table I. From the experiment results presented in FIG. 3, we know that CommC and CompC of S(L,4,20,N) are 159.74 kb and 14% (see Texture Downsample graphs FIGS. 3B & 3F), while they are 380 kb and 86.9% for S(H,0,300,Y) (see Enabling Grass graphs FIGS. 3D and 3H). Hence the CommC of the best setting (level 4) is 2.38 times of the lowest setting (level 1), while the CompC of the best setting (level 4) is 6.19 times of the lowest setting (level 1). With these maximum ranges, CommC of level 2 and level 3 are defined as 1.46 times and 1.92 times of level 1 respectively, while they are 2.73 times and 4.46 times for CompC. Once CommC and CompC for different levels are known, the optimal rendering settings can be selected resulting in an matrix as shown in FIG. 5 that defines specific rendering settings for each increment of adaptation level along CommC and CompC.

Instead of using the above look up table, parameters can be adjusted on the fly without pre-calculation of a look up table to impact on CommC and CompC in view of the above or similar qualitative observations. The qualitative observations provide logic for a set of rules to adjust parameters with a target goal in mind.

Adaptation Level Selection During Run Time

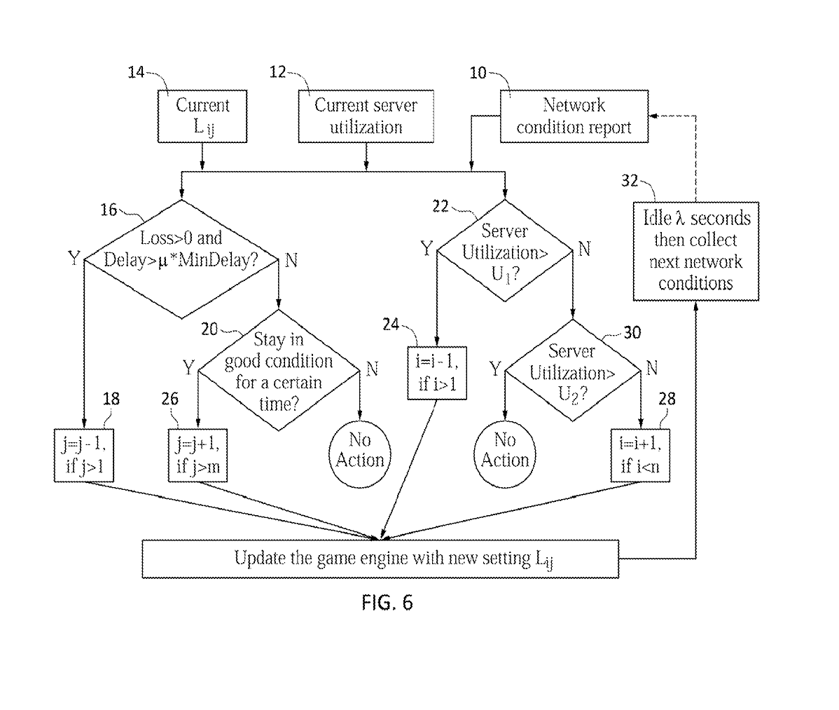

FIG. 6 shows an example level selection method for deciding when and how to switch the rendering settings during a video delivery session, such as a gaming session. The method of FIG. 6 monitors and responds to communication network conditions and server utilization, to satisfy the network and server computation constraints. As has been mentioned, other factors can cause constraints and such constraints can be monitored for the purpose of adjusting rendering in accordance with the invention.

The method of FIG. 6 receives or obtains information regarding the network condition 10 and the server utilization 12, and also has knowledge of the current adaptation level 14. The network conditions in step 10 can, for example, be determined based upon both network delay and packet loss as indicators to detect a level of network constraint. A decision 16 based upon network delay and packet loss determines whether to make an adjustment 18 or continue monitoring 20. In the best network conditions (not overloaded), packet loss rate is 0, but there is a certain minimum round-trip delay, denoted by MinDelay, due to the time needed to transmit a packet through the core network and RF link in the case where the end destination of video being delivered is a wireless client. FIG. 6 in the decision 16 uses μ*MinDelay (μ>1) as a threshold for round-trip delay together with the packet loss to estimate the constrained network.

A decision 22 detects server over-utilization, and uses a predetermined threshold U₁ as the upper threshold of GPU utilization. If GPU utilization is above this threshold then the GPU is over utilized. Another decision uses U₁ as a lower threshold of GPU utilization, indicating that the GPU is underutilized.

When either a constrained network or an over utilized server is detected, the level selection method will select a lower adaptation level (with lower cost) in step 18 or step 24. When the network condition and/or server utilization improves, the method will select a higher level (with higher cost, and thereby higher user experience). To avoid undue oscillations between adaptation levels, adaptation level changes can be limited. For communication cost level, for example, it can be increased 26 only when the network has stayed in the good condition (no packet loss, delay less than threshold) for a certain time as determined in the decision. Similarly, the computation cost level can be limited to increase 28 only when the server utilization is below U₂, the lower utilization threshold as determined by a decision 30.

It should be noted that the CommC level I and CompC level j are preferably independently calculated by separate threads, which makes it possible that CommC level I and CompC level j are increasing/decreasing simultaneously. Once the new levels are decided, optimal rendering settings are selected in a preferred embodiment by checking the look-up table in FIG. 5, and updated into the game engine.

Instead of using a look-up table, parameters can be adjusted on the fly without pre-calculation of a look-up table to impact on. CommC and CompC in view of the above or similar qualitative observations that parameters will have on CommC and CompC. For example, the higher settings of rendering parameters in Table I has higher CommC and CompC. One way of adjusting rendering settings without look up table is to vary the values of the rendering parameters in Table I from their current values to lower settings so as to reduce CommC and/or CompC incrementally, until CommC and/or CompC meet the constraints of network and computing server. Similarly, the parameter settings can be adjusted upward to increase CommC and/or CompC as needed. Qualitative observations regarding the effect of parameter changes on CommC and/or CompC can be used to provide guidance while adjusting the parameters. For example, depending on whether CommC or CompC level needs to be adjusted, a method can change the value of the parameter that has the most effect, as specified in the observations such as the four numbered observations in the above section “Characterization of communication and computation costs.” If both CommC and CompC levels need to be changed simultaneously, a parameter like View Distance, which has large effect on both CommC and CompC, can be instead used.

Joint Encoding and Rendering Adaptation Model

In addition to rendering adaptation, preferred embodiments also use encoding adaptation. In some instances, the network bandwidth available, in particular in mobile wireless networks, can sometimes change very rapidly. In such situations, using only rendering adaptation to satisfy the communication constraints may lead to unsatisfactory user experience, due to resulting rapid changes in the rendering settings. Preferred embodiments therefore also make use of encoding adaptation to adapt the video encoding bit rate. Conventional video bit rate adaptation techniques, including those mentioned in the background section of this application, can be used in conjunction with the rendering adaptation technique to address network constraints.

In a preferred Joint Rendering and Encoding Adaptation (JREA) method the encoding adaptation is used with rendering in the following manner. The encoding adaptation is used for fast response to a pattern of network conditions commonly observed in wireless networks, such as variations in network bandwidth within a relatively small bandwidth range, such that effects of network congestion are alleviated with little perceptual change in video quality. Rendering adaptation can be applied when the available network bandwidth changes significantly, which will happen less frequently. This will be particularly useful when the network bandwidth gets severely constrained, say below 300 kbps. In these cases, the rendered video resulting from rendering adaptation can still be encoded with an acceptable video quality, thus leading to an overall acceptable user experience.

In additional preferred embodiments, rendering adaptation is also implemented after encoding adaptation sets a bit rate, or after the bit rate has been set at a particular level for a given period of time. Once that occurs, rendering adaptation is then used to maximize video quality at a given bitrate.

The above embodiments associate rendering adaptation with a “rendering level”, which reflects the complexity of that rendering. Rendering level 1 has the lowest complexity, and rendering level in has the highest rendering complexity, and correspondingly the richest rendering graphics.

Similarly, several encoding bitrates can be defined to indicate the bitrate being used gaming video. For each rendering level a minimum encoding bitrate that is needed to ensure the resulting video has acceptable quality is defined. Similarly, for each bitrate used to encode gaming video, there is an optimum (maximum) rendering level that provides the best video quality.

Minimum Encoding Bitrate (MEB) for Each Rendering Level

Encoding adaptation will adapt video bitrate to the fluctuating network bandwidth to avoid network congestion. However, lowering video bitrate may lead to unacceptable gaming quality. Therefore, there is a Minimum Encoding Bitrate (MEB) below which gaming video quality will not be acceptable by game users. It should be noted that MEB are different for different rendering levels. Higher rendering levels will have higher MEB.

MEB for each rendering level can be measured off-line or can be calculated on-line. Thus, when encoding bitrate being used is lower than current MEB, rendering adaptation is utilized to get a lower required MEB, such that the user perceived video quality is acceptable. Table II shows the MEB result determined experimentally off-line for each rendering level for game PlaneShift. For example, in rendering level 4 requires at least 300 kbps video to satisfy minimum acceptable gaming video quality. Therefore MEB is 300 kbps for rendering level 4.

TABLE II
MINIMUM ENCODING BITRATE
FOR EACH RENDERING LEVEL

| Rendering Level | 4 | 3 | 2 | 1 |
|---|---|---|---|---|
| MEB | 300 | 250 | 200 | 150 |

Optimal Rendering Level for Each Encoding Bit Rate

While encoding bitrate adaptation reduces video quality to satisfy communication bandwidth constraints, rendering adaptation can improve video quality by lowering graphic rendering complexity. However, it is not good to excessively lower rendering level if video quality is already in the excellent condition. Therefore, for each encoding bitrate, there is an Optimal Rendering Level (ORL), which is the highest rendering where impairment of resulting video PSNR on user experience (See, e.g., “Modeling and Characterizing User Experience in a Cloud Server Based Mobile Gaming Approach,” Proceedings of the IEEE Global Communications Conference, Hawaii, December 2009) is minimized.

For each encoding bitrate, a preferred embodiment varies rendering levels while measuring their resulting video quality (PSNR). ORL for game PlaneShift is selected as presented in table III, that was calculated off-line.

TABLE III
OPTIMAL RENDERING LEVEL I FOR EACH ENCODING BITRATE

| | Encoding Bit rate | | | | | | | |
|---|---|---|---|---|---|---|---|---|
| | 700 | 600 | 500 | 400 | 300 | 250 | 200 | 150 |
| ORL | 4 | 3 | 3 | 2 | 2 | 2 | 1 | 1 |

INPUT PARAMETERS FOR JREA METHOD

Table III shows a few sample bit rates, but many more bit rates can be used in practice depending on the network. For example, for an LTE network, the bit rate range can be 10 Mbps to 500 kbps. Instead of levels, optimal rendering settings (values of rendering parameters) can be stored. In general, a function for optimal rendering level (ORL)=f_{ORL}(Encoding bitrate) can be implmented. One way of implementing the function is by pre-calculating and storing in a table as in Table III, but ORL can also be calculated on-line.

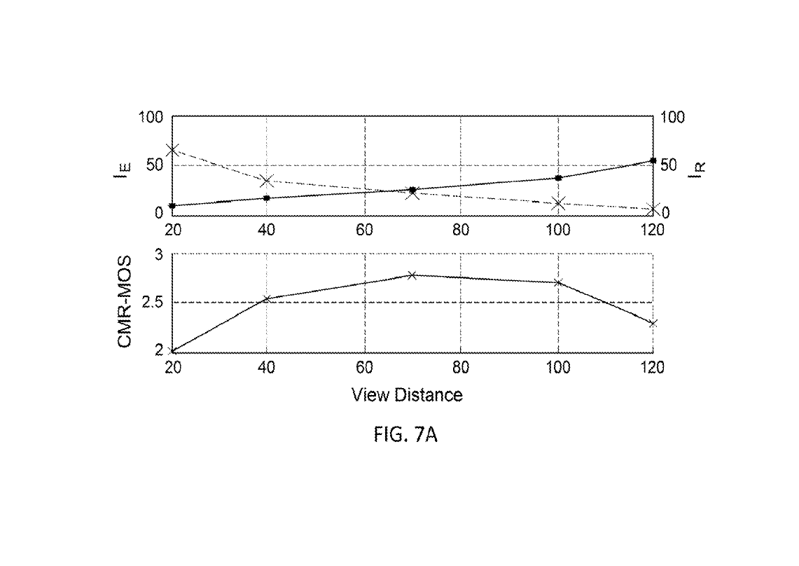

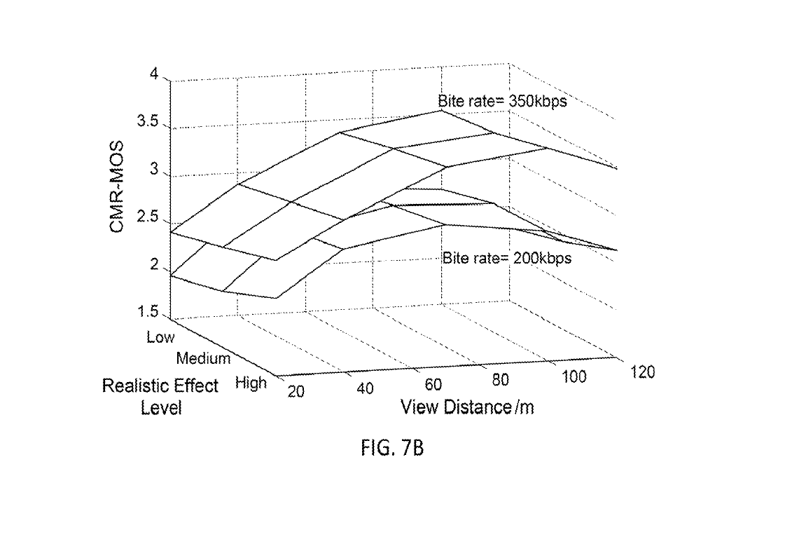

FIG. 7A shows results of a representative characterization experiment, for target video bit rate of 200 kbps. To find the optimal view distance for 200 kbps video streaming, the view distance was varied from 20 meters to 120 meters while computing the I_{R}, I_{E} and the CMR-MOS using the UE model discussed above. FIG. 7B shows the results—as expected, when view distance increases, I_{R} reduces, but I_{E} increases. Because the decreasing slope of I_{R} is bigger than the increasing slope of I_{E}, the overall CMR-MOS increases initially with increasing view distance. However, after about 70 meters of view distance, CMR-MOS starts to decrease as the decreasing slope of I_{R} is smaller than the increasing slope of I_{E} after that point. Therefore, the optimal view distance when the target video bit rate is 200 kbs is 70 meters, where it achieves the maximum CMR-MOS.

It should be also noted that the optimal rendering setting will be different for different network conditions (target video bit rates). FIG. 7B shows the simulation results using our the UE model for two rendering settings, view distance and realistic effect, and two network conditions, 200 kbps and 350 kbps. From FIG. 7B, it can be observed that the optimal view distance for bit rate 200 kbps is 70 m while it is 120 m for 350 kbps. For the realistic effect, it can be observed that a higher realistic effect will lead to a higher CMR-MOS score in both bit rates. Similar mappings can be used to develop optimal settings for each rendering parameter vis a vis bit rate.

Evaluating Input Parameters for Rendering and Encoding Levels

Different applications can have different triggers for rendering and encoding level changes. To illustrate this principal, a few different MMORPG games are considered. Preferred input parameters used for the games are given as an example to drive a decision of whether to decrease or increase the rendering levels and encoding bitrate during a gaming session. These parameters should be able to detect the current communication and computation conditions/constraints. Table IV illustrates excellent and acceptable millisecond delays for different games, Plane shift (PS), World of Warcraft (WoW), Need For Speed (NFS), and Professional Evaluation Soccer (PES). Plane shift and World of Warcraft are MMORPG games, Need for Speed is a simulation game, and Professional Evaluation Soccer is a sports game.

TABLE IV
THE RDELAY THRESHOLDS FOR DIFFERENT GAME TYPES

| | Quality | | | | | |
|---|---|---|---|---|---|---|
| | RD_{E} (Excellent) | | | RD_{A} (Acceptable) | | |
| Game | PS/WoW | NFS | PES | PS/WoW | NFS | PES |
| RDelay | 280 | 200 | 160 | 440 | 320 | 240 |
| (ms) | | | | | | |

Packet loss rate is widely used by traditional rate encoding adaptation schemes, and can be used to trigger joint rendering and encoding adaptation in accordance with the invention. This is not the most preferred measure to drive joint rendering and encoding, however, because it can lead to short-term rate oscillations, primarily due to rate adaptation for losses caused not by congestion, but other factors such as channel fading, which often occur in wireless networks.

Round trip delay as in Table IV is preferred as a measure to determine whether adaptation is necessary. Round trip delay will have noticeable increase when network is congested. Preferred embodiments in gaming use a Mobile Gaming User Experience (MGUS) model from “Modeling and Characterizing User Experience in a Cloud Server Based Mobile Gaming Approach,” Proceedings of the IEEE Global Communications Conference, Hawaii, December 2009) and associated Game Mean Opinion Score (GMOS). From this, it is possible to calculate round trip delay RDelay thresholds that need to be met to achieve excellent RD_{E} (GMOS>4.0), and acceptable RD_{A} (GMOS>3.0) mobile gaming user experience.

In a preferred embodiment defined in Table IV where response is driven by delay, the objective of joint rendering and encoding is to ensure that the round trip delay, RDelay, is lower than the user acceptable threshold RD_{A}, by appropriately increasing or decreasing the encoding and rendering levels.

Joint Adaptive Rendering and Encoding Method

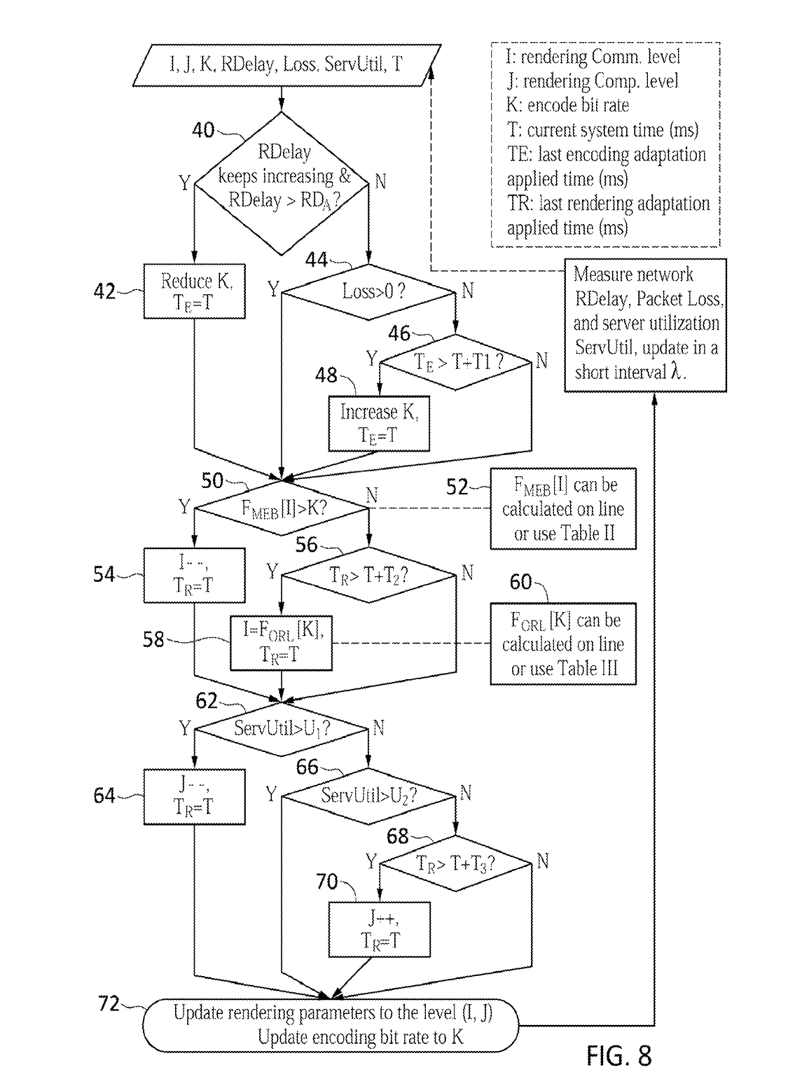

FIG. 8 illustrates a preferred embodiment joint rendering and encoding method that responds to network delay as defined in Table IV. At short time intervals λ, depending on the network conditions RDelay and Loss, and server utilizations ServUtil, JREA method decides to select a lower or higher rendering Comm level I, rendering Comp level J, and encoding bitrate K, such that 1) network round trip delay threshold RD_{A} is met, and 2) gaming video quality is maximized. The FIG. 8 method includes three principal operations deciding encoding rate, check/update rendering CommC level, check/update rendering CompC level. In addition to or instead of ServUtil, server cost, cloud cost, and data center cost. Cloud computing allows elasticity, that is, if one server gets fully utilized, another server can be instantiated—the pool of servers is limit less. The same can be true for data centers. For this reason, server, cloud and data center cost can be considered instead of or addition to reducing the computation load on a server based on server utilization. In this way, computation load based on cost of the number servers (hardware cost) or cloud/data center cost, which is cost of server+storage+bandwidth. In a cloud, cost of server can be either ownership cost, or utility cost model (cost per hour/day of usage).

With reference to FIG. 8, the encoding rate decision checks 40 for network round trip delay RDelay is over RD_{A}. The encoding bitrate K is reduced 42. If the delay is less than RD_{A}, then packet loss is checked 44. When there is no packet loss for a predetermined time, T₁, as checked 46, RDelay remains below RD_{A} and there is no packet loss, the encoding bitrate is increased 48. In a variation, the RDelay average is checked, such that if, during a certain period λ, if the network RDelay keeps increasing and its average value is greater than RD_{A}, then encoding bit rate K is decreased. In this variation that checks for RDelay average, during a certain period λ, if the network RDelay keeps increasing and its average value is greater than RD_{A}, encoding bit rate K is reduced. On the other hand, if for a significant time, T₁, RDelay remains below RD_{A} and there is no packet loss, the encoding bitrate K is increased.

The method then continues by checking the MEB against the CommC rendering level 150. If the rendering CommC I is greater than the MEB according to an on-line check or a check using off-line calculations 52 as defined in Table IV, then CommC level I is flagged for a decrease update 54. If MEB does not exceed the bit rate then for a predetermined period of time (meant to avoid undue oscillation) 56, then level I is increased 58, by on-line calculation or by a predetermined off-line calculated values in a look up table 60, such as Table III.

The last phase involves the CompC cost J, which is checked as in FIG. 6 by comparing server utilization ServUtil 62 to U₁, If ServUtil exceeds the upper threshold U₁, then CompC level J is flagged for decrease 64. Otherwise, if ServUtil is below U₂ 66 and rendering levels have not been changed for more than time T₃ 68 then CompC cost J is flagged for increase 70. With all of the changes to bit rate K, CommC I and CompC J, a preferred embodiment uses an increment of 1 level, although other techniques are possible, especially if there are high number of bit rates and encoding levels, such as incrementing by some multiple with the potential of overshooting, or making a qualitative judgment based upon the amount of comparison, such as of MEB exceeds K by more than a predetermined amount or ServUtil exceeds by more than a certain amount then changing by more than one incremental level. The bit rate K, CommC level I and CompC level J are then updated and the new CommC and CompC are used to select the optimal rendering and encoding parameters as discussed above and then updated into the game engine and video encoding server 72.

Cloud Mobile Gaming System

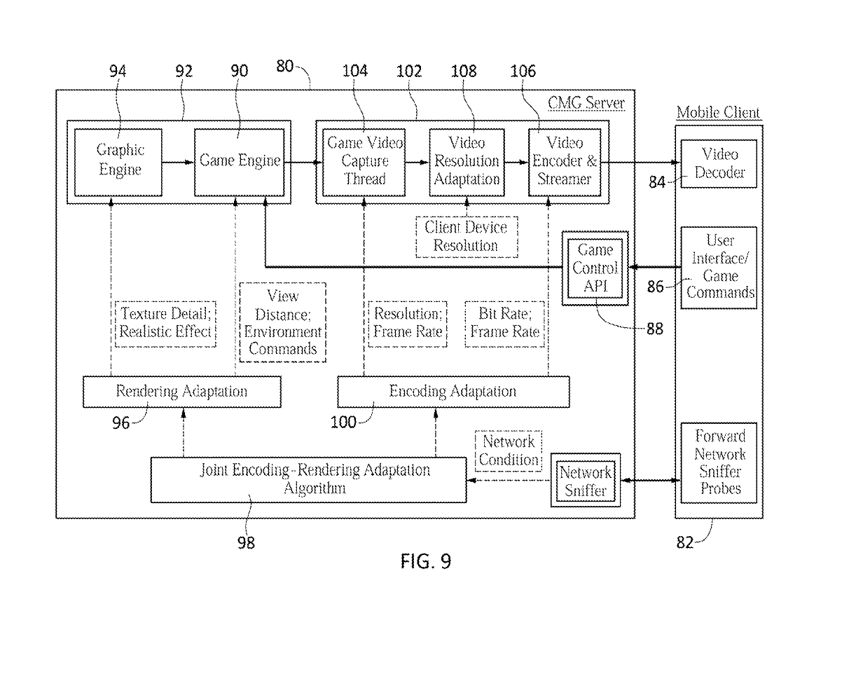

FIG. 9 illustrates a preferred system for cloud mobile gaming implementing adaptive joint rendering and encoding in accordance with FIG. 8 and the embodiments discussed above. The system includes a cloud mobile gaming server (CMG) 80 that serves mobile clients 82 (only client is illustrated but a practical system will have many mobile clients). The client(s) 82 and server 80 communicate over a network, such as a cell network. Each mobile client 82 includes a video decoder 84 that permits encoding a display of received video. Advantageously, the mobile client 82 can be “light”, not needing graphics rendering and game engine functions that are performed by the server 80. A user interface 86 provides user game commands to a game control application 88 on the server. Game control information for each user is sent to a game engine 90 (or other content in other types of applications) in a rendering pipeline 92 that also includes a graphic engine 94.

A rendering adaptation module 96 receives adaptive rendering information from the joint encoding and rendering algorithm 98 of FIG. 8 or in general accordance with the embodiments described above. The rendering adaptation module separates parameter updates according to whether the graphic engine 94 or the game engine 90 implements the parameter. For example, with the example embodiments discussed above, the graphic engine 94 receives updates concerning the texture detail and realistic effect, and the game engine 90 receives updates concerning view distance and environment details.

Similarly, an encoding adaptation module 100 receives encoding parameter from the joint rendering and encoding algorithm 98, and provides encoding information to appropriate sections/processors of an encoding pipeline 102. A game video capture thread 104 receives resolution frame rate adaptations and a video and encoder streamer 106. A video resolution adaptation receives information regarding client device resolution, which can be provided from the game control API 88. Network conditions are provided through probes 108 and a sniffer for detection 110. The probes 108 and sniffers determine network conditions are provided through a network probing mechanism: the CMG server 80 periodically sends a UDP probe to the mobile client, which includes the probe send out time and probe sequence number. Once a mobile client receives a probe, it will sends the probe back to the CMG server through the TCP connection. The difference of probe send out time and receive time can indicate the current network round-trip delay RDelay. Tthe packet loss rate PLoss can be calculated by checking the received probe sequence number. The algorithm also is aware of server utilization as discussed above.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method for graphics rendering adaptation by a server that includes a graphics rendering engine that generates graphic video data and provides the video data for encoding and communication via a communication resource to a client, the method comprising:
monitoring one or both of communication and computation constraint conditions associated with the graphics rendering engine and the communication resource;
setting at least one rendering parameter used by the graphics rendering engine based upon a level of communication constraint or computation constraint; and
repeating said monitoring and setting to adapt rendering based upon changes in one or both of communication and computation constraints.

2. The method of claim 1, wherein said monitoring monitors communication delay on the communication resource as a communication constraint.

3. The method of claim 2, wherein said monitoring monitors packet loss on the communication resource as a communication constraint condition.

4. The method of claim 1, wherein said monitoring monitors one or more of server utilization, server cost, cloud cost, and data center cost as a computation constraint.

5. The method of claim 1, further comprising setting encoding bit rate based upon a level of communication constraint.

6. The method of claim 5, wherein said setting of at least one rendering parameter is conducted after said setting encoding bit rate.

7. The method of claim 1, wherein:
said at least one rendering parameter includes a plurality of parameters;
said plurality of parameters include parameters that effect a cost of communication and parameters that effect a cost of computation; and
said setting adjusts a rendering parameter that affects a cost of communication in response to a monitored communication constraint and adjusts a rendering parameter that affects a cost of computation in response to a monitored computation constraint.

8. The method of claim 1, wherein the at least one rendering parameter includes one or more of realistic effect parameters, texture detail parameters, view distance parameters, and rendering frame rate, rendering resolution, and enabling background detail parameters.

9. The method of claim 8, wherein said setting selects among one or more of the realistic effect parameters, texture detail parameters, view distance parameters, and enabling background detail parameters based upon a calculated or determined in advance parameter-user experience impairment effect.

10. The method of claim 9, wherein the realistic effect parameters include one or more of a color depth parameter, multi-sample parameter, texture-filter parameter, and lighting mode parameter.

11. The method of claim 1, wherein said setting of at least one rendering parameter also sets a rendering level that is optimal in view of an encoding bitrate.

12. The method of claim 1, wherein the graphics rendering engine comprises a game engine, the server comprises a cloud server or data center server, and the communication resource comprises a mobile wireless network.

13. The method of claim 1, further comprising
a preliminary procedure to identify or calculate optimal rendering settings for different rendering adaptation levels, where each adaptation level represents a certain communication and computation cost; and
said setting conducts a run-time level-selection method that automatically adapts the adaptation levels, and thereby the rendering settings, such that the rendering cost will satisfy the communication and computation constraints imposed by fluctuating network bandwidth and server available capacity according to the optimal rendering settings.

14. The method according to claim 13, wherein said setting comprises:
deciding encoding bitrate used to encode the rendered video on the communication resource by, if network round trip delay RDelay or its average is over a predetermined delay or if the network round trip delay RDelay is increasing over a time period, reduce encoding bitrate, otherwise if for a predetermined time, RDelay or its average remains below the predetermined delay and there is no packet loss, then increase the encoding bitrate;
checking and updating the at least one rendering parameter, by selecting and updating a parameter that will affect communication cost, decreasing a level of the parameter that will affect communication cost if the encoding bit rate has decreased, otherwise, if the encoding bit rate has increased and remains increased for a predetermined time, increasing the level of the parameter that will affect communication cost; and
checking and updating the at least one rendering parameter, by selecting and updating a parameter that will affect computation cost depending upon a level of server utilization, decreasing a level of the parameter if server utilization is over a predetermined amount, otherwise if server utilization is below a predetermined amount for a predetermined time, increasing a level of the parameter.

15. A server that adaptively provides graphics to clients over a network, the server comprising:
a video rendering pipeline including a graphic engine and a content engine for rendering video;
an encoding pipeline for encoding video rendered by said video rendering pipeline;
communication monitoring means for monitoring communication network conditions;
computation cost monitoring means for monitoring computation costs; and
software for instructing the video rendering pipeline to adjust rendering parameters in response to communication network conditions monitored by said communication monitoring means and computation cost conditions monitored by said computation cost monitoring means, and for instructing the encoding pipeline to adjust encoding parameters in response to communication network conditions monitored by said communication monitoring means.
